(19) United States
(12) Patent Application Publication
(10) Pub. No.: US 2008/0261848 A1
(43) Pub. Date: Oct. 23, 2008

(54) Multifunctional Material Compositions and Methods

(76) Inventor: Enrique Hernandez, Brownsville, TX (US)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 12/104,265

(22) Filed: Apr. 16, 2008

Related U.S. Application Data
(63) Continuation of application No. 11/330,638, filed on Jan. 12, 2006, now abandoned.
Application No. 11/330,638 is a continuation-in-part of application No. 10/894,957, filed on Jul. 20, 2004, now abandoned.

(51) Int. Cl. C11D 3/08; C11D 17/08

(52) U.S. Cl. 510/218; 510/420; 510/337

(57) ABSTRACT

A compound for use in a detergent composition is provided that has formula X(SiO₂).(Na₂O).Z(H₂O), wherein X is about 0.5 to about 1.2, and Z is greater than about 0.1. Methods and systems for making the compound are also provided. The invention also describes materials comprising an alkali metal silicate characterized by a degree of polymerization less than or equal to about 2.5. Cleaning product compositions comprising a material of the invention, methods for making cleaning product compositions, and methods for cleaning comprising contacting a surface with a solution comprising a material of the invention are also provided. Additionally, methods for regulating the degree of polymerization of an alkali metal silicate in solution using pH are provided. The degree of polymerization may be regulated to be less than or equal to about 2.5. Furthermore, methods for cleaning by contacting a surface with an alkali metal silicate solution having a pH-regulated degree of polymerization are also provided.

### PRIORITY CLAIM

This application is a continuation of co-pending U.S. patent application Ser. No. 11/330,638 filed Jan. 12, 2006; which is a continuation-in-part under 35 U.S.C. §120 of and claims priority to U.S. patent application Ser. No. 10/894,957, filed on Jul. 20, 2004, now abandoned, the contents of which are hereby incorporated by reference in their entirety.

### TECHNICAL FIELD

The present invention relates generally to multifunctional detergent components and more particularly to metasilicate compositions and methods of efficiently making and using metasilicate compositions. In some embodiments, the present invention describes materials such as, multifunctional materials comprising alkali metal silicates that have monomeric components and a low degree of polymerization. The present invention also describes alkali metal silicate solutions having a pH-regulated degree of polymerization. In some specific embodiments, higher pH levels are shown to increase the desired monomeric components of the alkali metal silicates of the invention. In yet other embodiments, methods of regulating the degree of polymerization of an alkali metal silicate in solution using pH are described. This disclosure also describes cleaning product compositions comprising multifunctional materials of the invention as well as methods of formation of such cleaning products.

### BACKGROUND

Cleaning products may be grouped into four general categories: personal cleansing, laundry, dishwashing, and household cleaning. Within each category are different product types formulated with ingredients selected to perform a broad cleaning function as well as to deliver properties specific to that product. Cleaning products, such as detergents used for laundry and/or other general purpose cleaners, typically include numerous components. Each component of the cleaning product may perform one or more functions either in the manufacture or use of the detergent.

Typically, cleaning products generally include a surfactant and a builder. In addition, cleaning products may have several other components such as pH control agents, corrosion protectors, builders, conditioners, alkaline agents, fillers, carriers, or perfumes. Since each component of the cleaning product has its individual cost to produce, transport and store, it is often times desirable to have one component perform many functions. Therefore, materials that are multifunctional cleaning product or detergent components are sought to reduce the cost of making the cleaning product.

Surfactants are organic chemicals that change the properties of water. By lowering the surface tension of water, surfactants enable the cleaning solution to wet a surface (e.g., clothes, dishes, countertops) more quickly, so soil can be readily loosened and removed (usually with the aid of mechanical action). Surfactants also emulsify oily soils and keep them dispersed and suspended so they do not settle back on the surface.

Another important component of detergents and cleaners are builders. Builders may soften the water as well as enhance the detergent effect. Builders soften water by capturing calcium or magnesium cations within the water. By softening the water, the builders also enhance the effect of the surface-active material (surfactants) used as cleaning agents. For example, cleaning products or detergents typically contains surfactants which are used to lift dirt from the fabrics and to penetrate into the fabrics to remove embedded soil. Calcium or magnesium cations within the water cause the surfactant to be inactivated due to the formation of insoluble salts. Builders help to remove these cations that inactivate the surfactant thereby enhancing the effect of the cleaning product.

There are different types of builders and sometimes more than one type of molecule is involved to form a “builder system.” Builders function in several ways. They increase the alkalinity of the wash solution, which helps the surfactant activity and also helps to emulsify fats and oils in the soiled fabrics. They also help to “break” clay-types of dirt from fabrics, and combine with them to help prevent redeposition on fabrics. They also function to combine with hard water mineral ions, thus “softening” the water.

Softening water may prevent water hardness ions from reacting with other detergent ingredients, which could cause them to work less efficiently or precipitate from solution. Water hardness ions can form insoluble salts, which may become encrusted in fabrics and deposited on solid surfaces inside a washing machine. In this way, builders extend the life of the washing machine. Additionally, soil molecules are often bound to fabric surfaces by calcium ion bridging; removal of calcium ions therefore may help stain removal.

The primary function of builders is to reduce water hardness (e.g., Ca²⁺ and Mg²⁺). This can be done either by sequestration or chelation, by precipitation, or by ion exchange. Thus, builders are often divided into three general categories: (1) sequestrating/chelating builders, which are soluble builders and form soluble complexes with cations; (2) ion exchange builders, which are insoluble builders and form insoluble complexes with cations; and (3) precipitating builders, which are soluble builders and form insoluble complexes with cations. Complex phosphates and sodium citrate are common sequestering builders. Sodium carbonate and sodium silicate are precipitating builders. Sodium aluminosilicate (zeolite) is an ion exchange builder.

Sequestrating builders disperse and suspend dirt. In aqueous solutions, these compounds combine with metal ions, like calcium, to substantially inactivate the ion. Some sequestrating builders, like sodium tripolyphosphate (STPP), or sodium pyrophosphate, form complexes with mineral ions, which stay in solution and may be rinsed away. Over time and with exposure to water, STPP will decompose into a mono-phosphate, or “orthophosphate,” called trisodiumphosphate (“TSP”). TSP is often used for cleaning hard surfaces where a precipitate is not a problem, but due to its precipitate formation is not favored for laundry use, as the precipitate often forms a white film on fabrics. Moreover, the use of phosphate builders is limited or banned in many countries such as the United States, Japan as well as in much of Europe because of eutrophication. In Europe, and increasingly in the USA, compounds such as zeolites (aluminum silicates) and phosphonates (a form of phosphate not thought to promote eutrophication) are being used as substitutes for complex phosphates in laundry detergents.

Ion exchange builders include zeolites. Zeolites are porous alumino-silicate minerals that may be either a natural or manmade material for example, synthetic sodium aluminum silicates. Manmade zeolites are based on the same type of structure as natural zeolites. Zeolites are composed of a three-dimensional framework of SiO₄ and AlO₄ in a tetrahedron, which creates very high surface area. Zeolites act by entraining metal cations and water molecules into their framework and are used in detergents for their cation-exchanging capacity. Zeolites are widely used in detergents and represent 80-90% of the world market. Most modern laundry detergent powders and tablets that do not contain phosphates, contain zeolites. Zeolites replace the water hardness ions (e.g., Ca²⁺ and Mg²⁺) with Na⁺ ions. Zeolites, like clays, are insoluble in water and are present in the wash as finely dispersed crystals (with a diameter of ˜4 microns). Zeolite builders are expensive, non-soluble in aqueous liquids, and suffer from poor performance.

Common precipitating builders include sodium carbonate (soda ash or Na₂CO₃) and silicates. Precipitating builders generally have high alkalinity and are good for “breaking” soil from fabric, but often forms an insoluble compound with hard water mineral ions, and also with mineral ions in the soil they release from fabrics. The insoluble compounds that are formed may redeposit on fabrics and washer parts. On fabrics it can look like white lint or powder. On washer parts, it can form a rock-like scale which can be harmful to the washer mechanisms.

### SUMMARY

The present invention is directed, according to one embodiment, to a method of making a metasilicate compound, the method including mixing a sodium source, a silica source and sodium silicate to form a mixture with a substantially uniform SiO₂:Na₂O ratio throughout and heating the mixture to first and second temperatures to form the metasilicate compound.

Another embodiment of the present invention, describes methods of making a metasilicate compound, the method including combining a silica source and a sodium source and treating the silica source and the sodium source with steam to form a liquid metasilicate compound.

In yet another embodiment of the present invention, a system for making metasilicate compound is disclosed, the system including a mixer to mix a sodium source, a silica source and sodium silicate into a mixture with a substantially uniform SiO₂:Na₂O ratio throughout and a heater to heat the mixture to a first temperature of about 400° C. to about 700° C. In a further embodiment, the system includes a second heater to heat the mixture to a second temperature. In some embodiments, the second temperature is about 700° C. to about 900° C. and the silica source has a silica fine size of 100 mesh or greater. In other embodiments, the second temperature is about 950° C. to about 1500° C. and the silica source has a silica fine size of less than about 100 mesh. In one embodiment, the system further includes at least one duct to direct at least a portion of heat from the second heater to the first heater.

In another embodiment of the present invention, a system for making liquid metasilicate is disclosed, the system includes a tank to receive and steam agitate a sodium source and a silica source to form a liquid mixture having a substantially uniform SiO₂:Na₂O ratio throughout.

The present invention is also directed, according to one embodiment, to a compound for use in a detergent composition, the compound having the formula: X(SiO₂).(Na₂O).Z(H₂O), wherein X is about 0.5 to about 1.2, and Z is greater than about 0.1.

According to one embodiment, the present invention teaches a detergent composition comprising a cleaning agent and an effective amount of builder, the builder having the formula: X(SiO₂).(Na₂O).Z(H₂O), wherein X is about 0.5 to about 1.2, and Z is greater than about 0.1.

According to another embodiment, the present invention teaches a detergent composition comprising a cleaning agent and an effective amount of neutralizing agent, the neutralizing agent having the formula: X(SiO₂).(Na₂O).Z(H₂O), wherein X is about 0.5 to about 1.2, and Z is greater than about 0.1.

In one embodiment of the present invention, a detergent composition includes, by weight, about 1% to about 45% cleaning agent, and about 3% to about 95% a metasilicate compound having the formula: X(SiO₂).(Na₂O).Z(H₂O), where X is about 0.5 to about 1.2, and wherein Z is greater than about 0.1.

In another embodiment of the present invention, a detergent composition includes, by weight, about 13% to about 15% a cleaning agent; about 25% to about 30% a metasilicate compound having the formula: X(SiO₂).(Na₂O).Z(H₂O), wherein X is about 0.5 to about 1.2, and where Z is greater than about 0.1; about 45% to about 50% a filler; and about 10% at least one additive.

In one embodiment of the present invention, a detergent composition includes, by weight, about 15% to about 17% a cleaning agent; about 30% to about 40% a metasilicate compound having the formula: X(SiO₂).(Na₂O).Z(H₂O), wherein X is about 0.5 to about 1.2, and where Z is greater than about 0.1; about 45% to about 50% a filler; and about 3% to about 6% at least one additive.

The present disclosure, according to another embodiment, provides a material, for example a multifunctional material, including an alkali metal silicate. The alkali metal silicate may have a particular degree of polymerization.

In additional embodiments, the present disclosure provides a material comprising an alkali metal silicate wherein at least a portion of the alkali metal silicate is monomeric and the alkali metal silicate has a degree of polymerization less than or equal to about 2.5. In some embodiments, the pH of the solution of the alkali metal silicate is about 11 or higher to about 13 or higher. The present disclosure also provides cleaning product compositions comprising the materials as set forth above.

According to another embodiment, the invention provides methods for making a cleaning product composition comprising combining a material and a surfactant wherein, the material comprises a solution of an alkali metal silicate wherein, (i) at least portion of the alkali metal silicate is monomeric; (ii) the alkali metal silicate has a degree of polymerization less than or equal to about 2.5; and (iii) the pH of the solution of the alkali metal silicate is about 11 or higher to about 13 or higher.

The present disclosure also provides methods for regulating the degree of polymerization of alkali metal silicates in solution. Embodiments of this method are directed to forming a solution of an alkali metal silicate and regulating the pH of the solution to be approximately a value of pH of about 10 or higher. Thus, for example the pH may be 10 or higher, the pH may be 11 or higher, the pH may be 12 or higher, or the pH may be 13 or higher. Different pH values result in a desired degree of polymerization of the alkali metal silicate in the solution.

According to yet another embodiment, the present disclosure, provides methods for cleaning comprising contacting a surface with a solution comprising a material, the material comprising an alkali metal silicate characterized by a degree of polymerization less than or equal to about 2.5.

According to another embodiment, methods for making an alkali metal silicate solution are provided. In one embodiment, such methods include providing an initial solution of an alkali metal silicate characterized by a degree of polymerization greater than about 2.5, and adjusting the pH of the initial solution to a level sufficient to shift the degree of polymerization of the alkali metal silicate to a level less than or equal to about 2.5.

According to yet another embodiment of the present invention, a method for cleaning is provided. In some embodiments this method includes contacting a surface with a solution comprising an alkali metal silicate having a degree of polymerization less than or equal to about 2.5. The solution may have a pH selected to regulate the degree of polymerization of the alkali metal silicate.

### BRIEF DESCRIPTION OF THE DRAWINGS

A more complete understanding of embodiments of the present invention and advantages thereof may be acquired by referring to the following description taken in conjunction with the accompanying drawings, in which like reference numbers indicate like features, and wherein:

FIG. 1 illustrates a system for making metasilicate according to an embodiment of the present invention;

FIG. 2 illustrates another system for making metasilicate according to an embodiment of the present invention;

FIG. 3 illustrates a flow chart for a method of making metasilicate according to an embodiment of the present invention; and

FIG. 4 illustrates a flow chart for another method of making metasilicate according to an embodiment of the present invention.

### DESCRIPTION

An embodiment of the present invention relates to a metasilicate compound having the formula of X(SiO₂).(Na₂O).Z(H₂O), wherein X may be about 0.5 to about 1.2. Having a silica to sodium ratio in this range may allow for the enhanced solubility of the metasilicate. In this range the metasilicate may not have glassy characteristics. Also, the metasilicate may have a favorable alkalinity in this range. Below this range the metasilicate may be too alkaline for use in some detergent applications. In some embodiments of the present invention, X may be about 0.7 to about 1.2. In other embodiments, X may preferably be about 0.9 to about 1.1. In further embodiments, X may be about 0.7 to about 0.9.

In embodiments of the present invention, the value of Z in the formula, X(SiO₂).(Na₂O).Z(H₂O), may comprise greater than about 0.1. In embodiments where Z nears 0, the metasilicate may be relatively anhydrous. In embodiments where Z ranges from 0.1 to 9, the metasilicate is typically in a solid, crystallized form. Metasilicate having a low value of Z may be preferred in concentrated detergents that desire less bulk. Metasilicate having a low value of Z may also reduce storage, transportation and other costs associated with making detergents.

In other embodiments of the present invention, Z may preferably be 5. This may be referred to as metasilicate penta hydrate. Metasilicate penta hydrate is typically a solid form of metasilicate that has approximately five water molecules coordinated around each metasilicate crystal. It has been discovered that metasilicate penta hydrate may be advantageous when additional bulk is required for a detergent. It has further been discovered that the additional water adds bulk and weight to a detergent for a comparatively low cost. Roughly 42.5% of metasilicate penta hydrate's weight comprises water. Therefore, metasilicate penta hydrate may reduce the amount of filler (such as sodium sulfate) required for a particular detergent. Using water as filler, also may have environmental advantages over using sulfates.

In other embodiments of the present invention, the value of Z may range from 0.1 to 9. Here, one may vary the amount of water present in the metasilicate to have a desired property. For example, one may adjust the amount of water in the metasilicate to have a desired bulk. In some embodiments of the present invention, such as when the value of Z approaches the value of 10 or higher, the metasilicate may be present in a liquid form. It has been discovered that a liquid metasilicate may be desirable in detergent manufacturing processes, such as spray drying and making a liquid detergent.

In several embodiments of the present invention, the metasilicates may be used in different manufacturing processes as well as different detergent presentations. The manufacturing processes include tower, agglomerator, and liquid manufacturing processes. The metasilicates of the present invention may also be included in various forms of detergents and cleaning products. These products may include detergents and cleaning agents as well as concentrates in either solid, gel or liquid form.

It has been discovered that embodiments of the present invention allow the metasilicate to perform one or more roles in the detergent. The metasilicate may be suitable to serve as a builder in the detergent composition. As a builder, the metasilicate may soften the water by removing metal cations. When added as a builder, the metasilicate may replace traditional phosphate and zeolite builders. Embodiments of this invention also include combinations of metasilicates and traditional builders. An effective amount of builders in a detergent composition typically is composed of about 25% to about 30% of the detergent composition by weight.

In another embodiment, the metasilicate may serve as a neutralizing agent in the final detergent composition. As an alkaline material, the metasilicate may act to neutralize the surfactant. By serving as a neutralizing agent, the metasilicate may reduce the amount of other alkaline material needed in the detergent composition. For example, the amount of soda ash used as a neutralizing agent in a detergent may be reduced. An effective amount of neutralizing agent in a typical detergent composition composes about 1% to about 5% of the detergent composition by weight.

In another embodiment, the metasilicate of the present invention may serve as a filler. Conventional detergents may comprise, by weight, about 45% to about 50% filler material such as sodium sulfate. Hydrated forms of metasilicate, such as metasilicate penta hydrate, may allow for a more cost efficient filler material.

Other embodiments allow the metasilicate to serve, among other functions, as a pH control agent, a corrosion protector, a conditioner, and/or an alkaline agent, and/or more than one of the discussed functions.

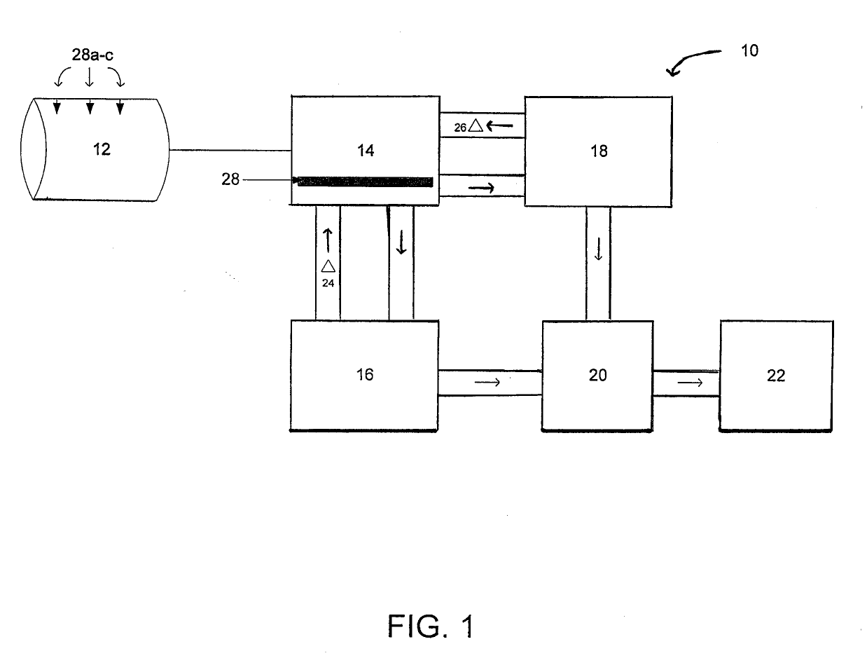

FIG. 1 illustrates system 10 for making metasilicate according to an embodiment of the present invention. System 10 includes mixer 12. Mixer 12 may be operable to receive, mix and agglomerate a sodium source, a silica source, and sodium silicate. Mixer 12 may be a finger, ribbon, or some other mixer suitable for the purpose.

Mixer 12 mixes the sodium source, silicon source, and sodium silicate so as to form a mixture with a substantially uniform SiO₂:Na₂O ratio throughout. A substantially uniform SiO₂:Na₂O ratio throughout means a mixture that has a roughly even dispersion of the individual ingredients all the way through the mixture. Having a substantially uniform SiO₂:Na₂O ratio throughout may allow suitable contact area between the sodium source, silicon source, and sodium silicate so as to react to form a metasilicate compound. In certain exemplary embodiments, the SiO₂:Na₂O ratio has a ratio of about 0.5 to about 1.2 SiO₂ to about 1 Na₂O.

In some embodiments of the present invention, the sodium source may be soda ash (Na₂CO₃) and/or caustic soda (NaOH) and/or a mixture of more than one soda source. In another embodiment, the silicon source comprises silicon dioxide (SiO₂). In other embodiments, the sodium silicate may be in a liquid or dry form. As a liquid sodium silicate form, mixer 12 may be able to spray the sodium silicate into the mixture using nozzles 28a-c.

The silica source may comprise a fine size ranging from about 40 mesh to about 180 mesh. A larger mesh number will indicate a smaller fine size. Therefore, a silica particle with a fine size of 120 mesh will be smaller (finer) than a silica particle with a fine size of 100 mesh. And a silica particle with a fine size of 80 mesh will be larger (courser) than a silica particle with a fine size of 100 mesh.

Associated with mixer 12 is heater 14. Heater 14 receives the mixture from mixer 12 and heats the mixture to a first temperature. In embodiments of the present invention, the first temperature has a range of about 400° C. (degrees Celsius) to about 900° C. Heating the mixture may encourage the decomposition of the sodium source and silicon source to form reactive species. In certain embodiments, heater 14 may provide enough heat to react the mixture to form metasilicate. Heater 14 may serve additional functions in the reaction. For example, by heating the mixture to a first temperature, which may be lower than a second temperature, the reaction mixture may be heated at a slower, more even, pace. This may prevent the silicon source of the mixture from vitrifying upon exposure to a high temperature source.

Heater 16 may be associated with heater 14. Heater 16 is operable to receive the mixture from heater 14. Heater 16 heats the mixture to a second temperature. In embodiments of the present invention, the second temperature is in the range of about 700° C. to about 900° C. Heater 16, it is believed, serves to more fully activate and react the mixture to form a metasilicate compound. In certain exemplary embodiments, heater 16 and heater 14 may be the same heating device. In other exemplary embodiments, heater 16 may be a rotary kiln, calcinator, an oven, a furnace or the like.

Associated with heater 14 may be heater 18. Heater 18 is operable to receive the mixture from heater 14. Heater 18 heats the mixture to another second temperature. In certain exemplary embodiments, the second temperature is in the range of about 950° C. to about 1500° C. Heater 18, it is believed, serves to more fully activate and react the mixture so to form a metasilicate compound. In certain exemplary embodiments, heater 18 and heater 14 may be the same heating device. In further embodiments, heater 18 may be the same heating device as heater 16. In other exemplary embodiments, heater 18 may be a rotary kiln, smelter, an oven, a furnace, or the like.

In embodiments of the present invention, system 10 may have both heater 16 and heater 18, or system 10 may only have heater 16 or heater 18. Many factors may determine if the manufacturer uses heater 16 or heater 18. One factor may be energy costs of using heater 16 versus heater 18. Another factor may include the fine size of the silica source. Typically, if the silica fine size is larger, hence a smaller mesh size, the mixture will go to heater 18. For example, in embodiments where the silica source has a silica fine size of about 100 mesh or less, system 10 may use heater 18. In embodiments where the silica fine size is about 100 mesh or greater, system 10 may use heater 16.

In one embodiment of the present invention, system 10 may be automated to produce continuous quantities of metasilicate compound. In an embodiment, system 10 may include sieve 28 to separate particles depending on the particle's silica fine size. Although FIG. 1 shows sieve 28 as part of heater 14, sieve 28 may be placed apart from heater 14. Sieve 28 may allow for finer silica particles to be heated by heater 16 while letting coarser silica particles to be heated by heater 18.

In certain exemplary embodiments of the present invention, system 10 has at least one duct 26 to direct a portion of the heat from heater 18 to heater 14. In other exemplary embodiments, system 10 has at least one duct 24 to direct a portion of the heat from heater 16 to heater 14. Ducts 24 and 26 may allow for more efficient use of energy in system 10 by using excess or residual heat from heaters 18 and 16 to help and/or heat heater 14.

In embodiments of the present invention, system 10 may further comprise hammer mill 20. Hammer mill 20 may serve to reduce the size of the metasilicate compound produced by system 10. In embodiments of the present invention, hammer mill 20 may also be a grinder or the like.

In other embodiments of the present invention, system 10 may comprise sprayer 22. Although the illustrated embodiment shows sprayer 22 following hammer mill 20, sprayer 22 may be located before hammer mill 20. Sprayer 22 may serve to add water to the metasilicate compound produced by system 10.

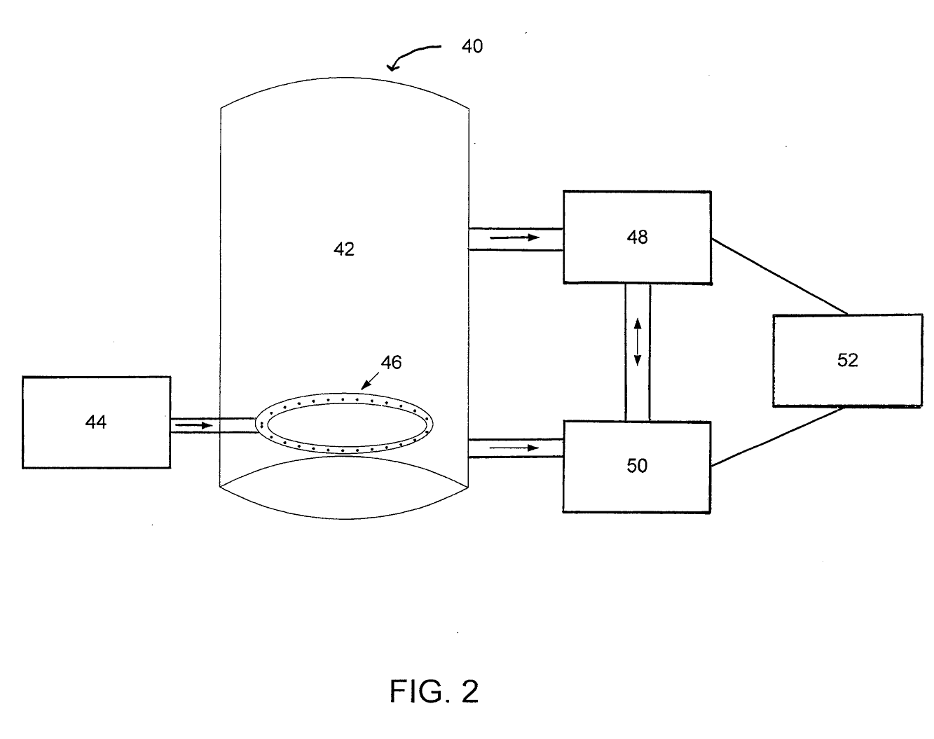

FIG. 2 illustrates system 40 of making a metasilicate compound. System 40 includes tank 42. Tank 42 is operable to receive a silica source and a sodium source. In certain exemplary embodiments, tank 42 may be an autoclave or the like. In other exemplary embodiments, tank 42 may be a cylindrical pressure reactor. In some embodiments of the present invention, the silica source may include silicon dioxide (SiO₂). In other embodiments, the sodium source may include caustic soda (NaOH). In further embodiments, the silica source may include soda ash (Na₂CO₃).

Tank 42 serves to allow the sodium source and silica source to be treated with steam and preferably agitate the same. In the illustrated embodiment in FIG. 2, boiler 44 provides tank 42 with a steam source. Tank 42 may have steam ring 46 disposed proximate to the bottom of tank 42 to steam the sodium source and silica source (and preferably agitate the same), to form a liquid metasilicate mixture with a substantially uniform SiO₂:Na₂O ratio throughout. In certain exemplary embodiments of the present invention, the SiO₂:Na₂O ratio has a ratio of about 0.5 to about 1.2 SiO₂ to about 1 Na₂O. In other embodiments, the SiO₂:Na₂O ratio has a ratio of about 0.7 to about 1.2 SiO₂ to about 1 Na₂O.

In some embodiments of the present invention, system 40 may further comprise vessel 50. Vessel 50 may serve to help solidify and/or crystallize the liquid metasilicate into a more solid form; for example, it may produce solid metasilicate penta hydrate. In certain exemplary embodiments, the liquid metasilicate may be seeded to encourage a transformation, e.g. a crystallization.

In other embodiments of the present invention, oven 48 may be associated with vessel 50 or tank 42. Oven 48 may serve to reduce the water content of the liquid metasilicate compound or crystallized and/or solid metasilicate compound. Following the teachings of the present invention, one may adjust the water content of the metasilicate compound depending on the desired end detergent product.

System 40, in certain embodiments, may further comprise hammer mill 52. Hammer mill 52 may be associated with vessel 50 and/or oven 48. Hammer mill 52 may serve the same function as hammer mill 20 in system 10 described above and not repeated here.

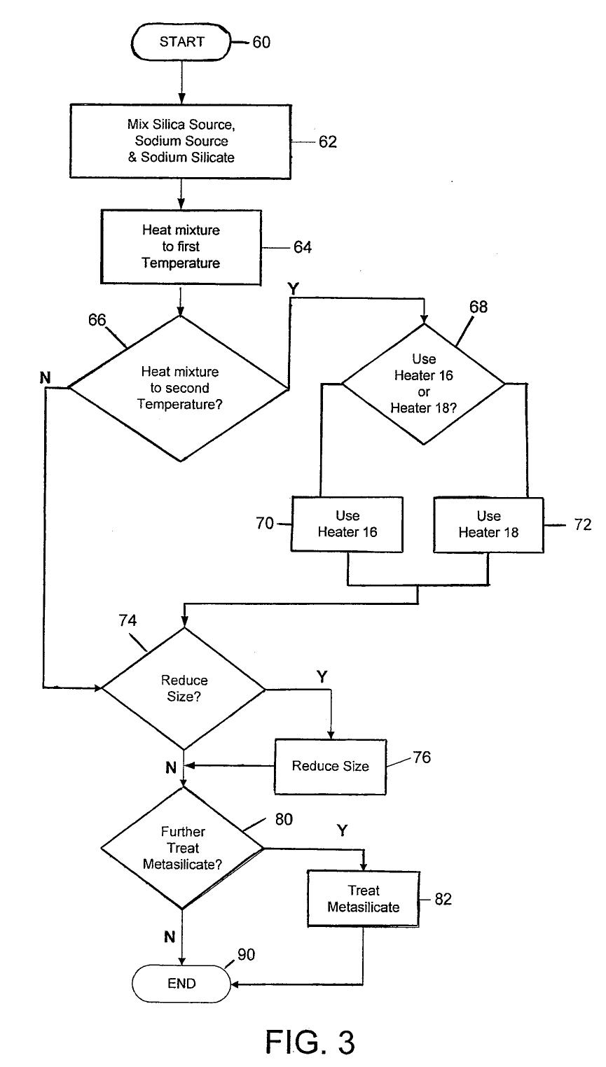

FIG. 3 illustrates a method of making metasilicate according to embodiments of the present invention. The method starts at step 60. The method then proceeds to step 62 where a sodium source, a silica source, and sodium silicate are mixed. Mixer 12 may be used for this purpose, which in some embodiments may be a finger mixer or a ribbon mixer or the like to achieve the desired purpose. This step preferably forms a mixture with a substantially uniform SiO₂:Na₂O ratio throughout.

Once the mixture is formed, the method proceeds to step 64, where the mixture is heated to a first temperature. In certain embodiments, the first temperature may be in the range of about 400° C. to about 700° C. At step 64, it is believed a pre-decomposition of the sodium source and silica source may occur. In other embodiments, the sodium source, silica source, and sodium silicate may react to form metasilicate compound.

At step 66, the mixture may be heated to a second temperature. If the mixture is not heated to a second temperature, then the method proceeds to step 74. If the mixture is heated to a second temperature, then the method proceeds to step 68.

At step 68, the mixture may proceed to heater 16 or heater 18 depending upon the circumstances. One factor to be considered at step 68 is the fine size of the silica source. It has been discovered that it is preferred to send a mixture with a silica fine size from about 40 to about 100 mesh (100 mesh or less) to heater 18. And it has been discovered that it is preferable to send a mixture with a silica fine size from about 100 to about 180 mesh (100 mesh or greater) to heater 16. If the mixture is heated in heater 16, the method proceeds to step 70. At step 70, heater 16 heats the mixture to a second temperature. In some embodiments, the second temperature may range from about 700° C. to about 900° C. It is believed that due to this heating step, the mixture more fully reacts to produce a desirable metasilicate compound.

At step 68, if the mixture is heated by heater 18, the method proceeds to step 72. At step 72, heater 18 heats the mixture. In one embodiment, heater 18 heats the mixture to a temperature in the range of about 950° C. to about 1500° C.

In embodiments where the method allows input of silica of varying silica fine size, such as automated applications, sieve 28 may separate the mixture into two separate mixtures. Then the method would use both steps 70 and 72.

Preferably, after the mixture has been heated to a second temperature, either through use of heater 16 or heater 18, or in a process that uses both heater 16 and heater 18, and the method proceeds to step 74.

At step 74, the individual particles of the metasilicate compound may be reduced in size. The size of the particles of metasilicate may be reduced so that an end detergent or cleaner has a certain desired characteristic. If it is not desired to reduce the particle size of the metasilicate, the method proceeds to step 80. If it is desired to reduce the size of the individual particles of metasilicate, the method proceeds to step 76 where hammer mill 20 may reduce the individual particle size of the metasilicate. Once the metasilicate particle size has been reduced to a size desired, the method proceeds to step 80.

At step 80, the metasilicate may be further treated or for example, hydrated. Because the current method uses heat, the metasilicate compound may be relatively anhydrous. It may be desirable that the metasilicate compound have a desired level of hydration so that the metasilicate compound has a desired bulk or melting temperature. If the metasilicate compound is not hydrated or further treated, the method proceeds to step 90 where the metasilicate compound is ready for use. If the metasilicate compound is further treated, the method proceeds to step 82 where, in an embodiment, sprayer 22 hydrates the metasilicate compound to a desired level. After the metasilicate compound has been hydrated, the method proceeds to step 90 where the metasilicate compound is ready for use.

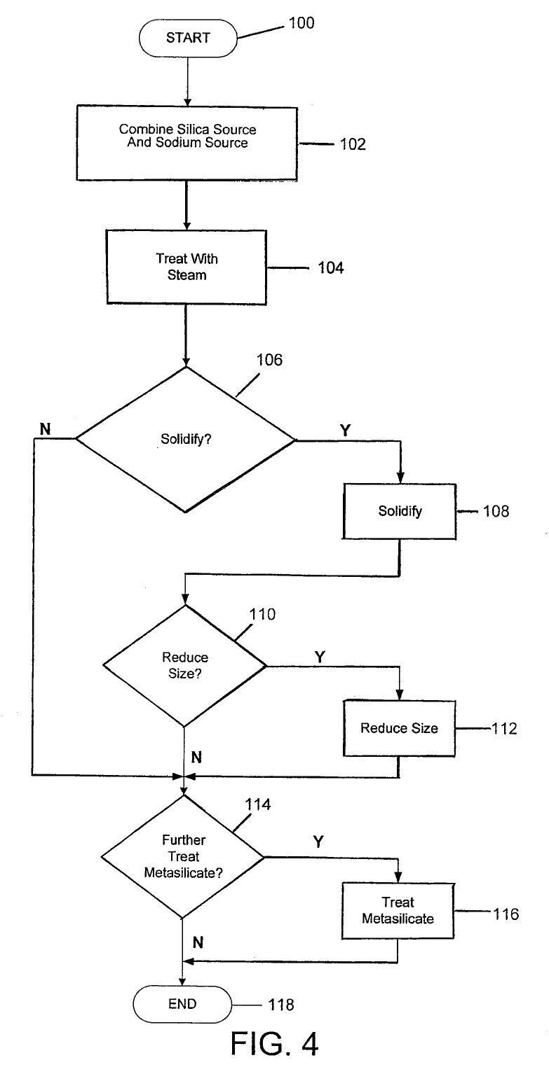

FIG. 4 illustrates a flow chart for another method of making metasilicate according to embodiments of the present invention. The method starts at step 100. The method then proceeds to step 102 where a silica source and a sodium source are combined. In an embodiment, the silica source and sodium source are combined in tank 42. Once the silica source and the sodium source are combined, the method proceeds to step 104.

At step 104 the silica source and sodium source are treated with steam, preferably agitating the same. Steam may be provided by boiler 44 and distributed to tank 42 through steam ring 46. At step 104, liquid metasilicate compound may be produced. In certain embodiments, the metasilicate has a SiO₂:Na₂O ratio of about 0.5 to about 1.2 SiO₂ to about 1 Na₂O. In another embodiment of the present invention, the metasilicate has a ratio of about 0.7 to about 1.2 SiO₂ to about 1 Na₂O.

Once the liquid metasilicate compound has been produced, the method proceeds to step 106. At step 106, the liquid metasilicate may be transformed into a solid form, e.g., crystallized. If the liquid metasilicate is not transformed, the method proceeds to step 114. If it is desirable to solidify or crystallize the metasilicate, the method proceeds to step 108.

At step 108, the liquid metasilicate compound may enter vessel 50. Vessel 50 allows the liquid metasilicate compound to solidify or crystallize. In certain embodiments, seed may be added to the liquid metasilicate compound in order to encourage solidification. After step 108, a solid metasilicate compound is produced. In certain embodiments of the present invention, the solid metasilicate compound is metasilicate penta hydrate. Once a solid metasilicate is produced, the method proceeds to step 110.

At step 110, the size of the individual particle size of the metasilicate may be reduced if desired. If it is not desired to reduce the size of the individual particles of metasilicate, the method proceeds to step 114. If it is desirable to reduce the size of the individual particles of the metasilicate, the method proceeds to step 112 where hammer mill 52 may reduce the individual particle size of the metasilicate. Once the metasilicate has been reduced to a desired size, the method proceeds to step 114.

At step 114, the solid or liquid metasilicate compound may be further treated, for example, to remove water. Because the reaction may occur with steam, the metasilicate compound produced is relatively hydrated. However, it may be desirable to have a metasilicate compound with a particular water content. If the metasilicate compound is not treated to remove water, the method proceeds to step 118 where the metasilicate compound is ready for use. If the metasilicate compound is to be treated to remove water, oven 48 or the like may be used to remove water content from the metasilicate compound. Once the metasilicate has a desired water content, the method proceeds to step 118 where the metasilicate compound is ready for use.

According to an embodiment of the present invention, a detergent composition includes a cleaning agent and a metasilicate compound having the formula X(SiO₂).(Na₂O).Z(H₂O), where X is about 0.5 to about 1.2, and where Z is greater than about 0.1. In an embodiment, the detergent composition includes, by weight, about 1% to about 45% cleaning agent; and about 3% to about 95% the metasilicate compound.

The cleaning agents of the present invention include surfactants. Suitable surfactants may include anionic surfactants, cationic surfactants, nonionic surfactants, amphoteric surfactants, and mixtures thereof. The anionic surfactant may include selected from alkylbenzene sulfonate, alkyl sulfate, alkyl ethoxy ether sulfate, and mixtures thereof. A preferred surfactant includes linear alkylbenzene sulfonate. In embodiments of the present invention, the cleaning agent may also comprise soda ash. In certain embodiments, the cleaning agent, for example the surfactant, may form a salt with the soda ash, for example a sodium salt linear alkylbenzene sulfonate. In other embodiments, potassium and/or ammonium may be used to form a salt with the cleaning agent.

The detergent compositions of the present invention may also include the following additives. Additives, for the purpose of this disclosure, include, but are not limited to, supplemental builders, chelating agents, dispersing agents, soil release agents, enzymes, bleaching agents (including photobleaches and borates such as sodium perborate), fabric softening clays, dye transfer inhibiting ingredients, fillers, optical brighteners, water, solvents, alkaline agents, conditioners, corrosion protectors, bluing agents, caking preventatives, antioxidants, citrates, redeposition agents, dyes, pigments, germicides, perfumes, polyethylene glycols, glycerines, sodium hydroxides, alkylbenzenes, fatty alcohols, and combinations thereof. One skilled in the art, with the benefit of this disclosure will recognize appropriate additives desired for a detergent application.

The supplemental builders may include phosphate-containing detergent builders; inorganic non-phosphate builders, including alkali metal silicates, carbonates, citrates, and aluminosilicates; and other organic builders.

The supplemental fillers may include sodium sulfate, calcium carbonate, talc and hydrated magnesium silicate-containing minerals.

In an example embodiment of the present invention, a detergent composition includes, by weight, about 13% to about 15% a cleaning agent; about 25% to 30% a metasilicate compound having the formula X(SiO₂).(Na₂O).Z(H₂O), where X is about 0.5 to about 1.2, and where Z is greater than about 0.1; about 45% to about 50% a filler; and about 10% at least one additive. In an embodiment, the filler material is sodium sulfate.

In another example embodiment of the present invention, a detergent composition includes, by weight, A detergent composition comprising, by weight, about 15% to about 17% a cleaning agent; about 30% to about 40% a metasilicate compound having the formula: X(SiO₂).(Na₂O).Z(H₂O), where X is about 0.5 to about 1.2, and where Z is greater than about 1; about 45% to about 50% a filler; and about 3% to about 6% at least one additive.

In an example embodiment of the present invention, a detergent composition includes, by weight, about 15% to about 18% a cleaning agent; about 24% to about 38% a metasilicate compound having the formula: X(SiO₂).(Na₂O).Z(H₂O) where X is about 0.5 to about 1.2, and where Z is greater than about 0.1; about 35% to about 40% a filler; and about 10% to about 12% at least one additive.

In another example embodiment of the present invention, a detergent composition includes, by weight, about 15.5% to about 18% a cleaning agent; about 35.5% to about 41.5% a metasilicate compound having the formula: X(SiO₂).(Na₂O).Z(H₂O), where X is about 0.5 to about 1.2, and where Z is greater than about 0.1; about 37.5% to about 43.5% a filler; and about 4% to about 6% at least one additive.

In certain exemplary embodiments of the present invention, a detergent composition includes, by weight, about 13% to about 15% a cleaning agent; about 29% to about 35% a metasilicate compound having the formula: X(SiO₂).(Na₂O).Z(H₂O), where X is about 0.5 to about 1.2, and where Z is greater than about 0.1; about 48% to about 54% a filler; and about 2% to about 4% at least one additive.

In other exemplary embodiments of the present invention, a detergent composition includes, by weight, about 13.5% to about 15% a cleaning agent; about 30% to about 34.5% a metasilicate compound having the formula: X(SiO₂).(Na₂O).Z(H₂O), where X is about 0.5 to about 1.2, and where Z is greater than about 0.1; about 48.5% to about 54% a filler; and about 2% to about 3% at least one additive.

In another embodiment of the present invention, a detergent composition includes, by weight, about 20% to about 22% a cleaning agent; about 24% to about 25% a metasilicate compound having the formula: X(SiO₂).(Na₂O).Z(H₂O), where X is about 0.5 to about 1.2, and where Z is greater than about 0.1; and about 50% to about 55% a filler. In a further embodiment, the detergent composition may further include at least one additive.

The present disclosure also provides a material, for e.g., a multifunctional materials comprising alkali metal silicates characterized by a degree of polymerization less than or equal to about 2.5. According to one embodiment, at least portion of the alkali metal silicate is monomeric, the alkali metal silicate has a degree of polymerization less than or equal to about 2.5, and the pH of the solution of the alkali metal silicate is about 11 or higher to about 13 or higher. Some exemplary alkali metal silicates of the invention are sodium silicate or potassium silicate.

When placed in a liquid, for example water, the multifunctional materials of the invention can form a multifunctional material solution. In solution, the multifunctional material may comprise silicate anions of various distributions. The anionic species distribution (i.e., silicate speciation) may affect the properties of the silicate.

The silicate ions present in a solution may exist as an equilibrium of monomeric and polymeric species. In solution, polymeric silicate species are known to form porous film deposits that appear white and opaque when dried, which is generally not a desirable form of deposition on fabrics or metals. In contrast, alkali metal silicate solutions in which monomeric silicate species may predominate, may form non-porous and clear deposits. As a result, solutions with primarily monomeric species may be more useful in many applications, such as cleaning applications in which a visible film is undesirable.

The concentrations of monomer and polymer in the equilibrium depend in part on the silica content and the SiO₂:Na₂O ratio of the solution. The monomeric species include silicon oxides that are not bonded to any other silicon atoms (e.g., SiO₄⁴⁻). Structurally, a monomeric silicon oxide may be represented as a tetrahedral anion with a silicon atom at the center of an oxygen-cornered, four sided pyramid. Other atoms may be associated with these oxygen atoms, such as hydrogen, sodium, or potassium. The oxygen atom of the silicon oxide monomer may be linked to other silicon atoms through tetrahedral coordination. In this way other, “polymerized” forms of silicon oxide anions may be formed. In polymeric forms of silicon oxides, the silicon atom of a monomer may be linked to between one and four other silicon atoms through a shared oxygen, which ultimately may form two- and three-dimensional structures.

A shorthand for representing the monomeric and polymeric species in a silicate solution uses the ratio of silicon dioxide to a alkali-metal oxide as follows: xSiO₂:M₂O, in which “M” is an alkali metal (e.g., sodium (Na) or potassium (K)) and “x” represents the weight ratio of silica to alkali-metal oxide. The electrical charges of the anions may be balanced by the sodium or potassium cations. Monomeric species form at SiO₂:Na₂O ratios of from about 0.5 to about 1.5. Polymeric species form at SiO₂:Na₂O ratios of from above about 1.5. To illustrate, a concentrated silicate solution having a SiO₂:Na₂O ratio of 1.0 or 0.5 mainly consists of SiO₃⁻² and HSiO⁻; whereas solutions with higher SiO₂:Na₂O ratio are characterized by increasing polymer concentration and increasing polymer size (up to 30 nm diameter). See R. K. Iler, The Chemistry of Silica, John Wiley and Sons, New York (1979). At ratios greater than about 2.0, polymer species begin to form as solids in the solution. Table 1 shows how the SiO₂:Na₂O ratio affects the degree of polymerization of an sodium silicate solution. See Nauman & Debye, J. Phys. Chem. 55:1 (1951).

TABLE 1

| SiO₂:Na₂O | Degree of | Molecular |
|---|---|---|
| Ratio | polymerization | weight |
| 0.48 | — | 60 |
| 1.01 | — | 70 |
| 2.0 | 2.5 | 150 |
| 2.2 | 3 | 180 |
| 2.6 | 7 | 420 |
| 3.1 | 15 | 900 |
| 4.0 | 27 | 1600 |

As mentioned above, the concentrations of monomer and polymer also depend in part on the silica content of the solution. Thus, for example, adding a silica source (e.g., colloidal silicate) to a high-ratio silicate solution may increase the SiO₂:Na₂O ratio, thereby forming more polymeric species. Monomeric species are better able to sequester cations (e.g., calcium cations) than polymeric species. The presence of the monomeric species may be measured using molybdic acid reagent as described in G. B. Alexander, “The Reaction of Low Molecular Weight Silicic Acids with Molybdic Acid” J. Am. Chem. Soc. 75:5655-7 (1953).

Accordingly, as discussed above, the distribution of monomer and polymer species in a multifunctional material solution also may vary based on changes in the solution's chemical environment. In solution, polymeric silicate species are known to form porous film deposits that appear white and opaque when dried, which is generally not a desirable form of deposition on fabrics or metals. In contrast, multifunctional materials, in which monomeric silicate species may predominate, may form non-porous and clear deposits.

Multifunctional material of various embodiments of the disclosure may be useful in any application that may utilize one or more of the following: a builder, a conditioner, an alkaline agent, a filler, a carrier, an antiredeposition agent, a corrosion inhibitor, processing aid (i.e., provides physical characteristics, such as proper pour or flow, viscosity, solubility, stability, and density), and a neutralizing agent.

Multifunctional materials may be included in a cleaning product composition, and when included in such a composition, smaller amounts of active ingredients (or none at all, in some cases) may be used in the cleaning product composition while achieving the same or better cleaning performance. The multifunctional materials of the present disclosure may be capable of softening water and tend not to deposit on the fibers of the cloth being washed. Multifunctional materials also have improved builder properties and perform better than or equivalent to phosphate builders. When used in a cleaning product composition, multifunctional materials may be capable of inhibiting the redeposition of soils, as well as inhibiting the corrosion of metals by, for example, synthetic detergents and complex phosphates. Multifunctional materials also may supply and maintain alkalinity, which assists cleaning, help keep removed soil from redepositing during washing, and emulsify oily and greasy soils.

The multifunctional materials of the present disclosure may be made using methods known in the art. For example, a multifunctional builder may be made by mixing together two or more natural or partially treated (ground or comminuted) primary raw materials or minerals, in proportions according to the desired SiO₂:Na₂O ratio, raising the mixture to a reacting temperature, such as by introducing the mixture into a furnace, reacting the mixture at the reacting temperature, and forming the multifunctional builder. One or more of the materials can be in the molten state upon mixing of the other ingredients. The process system for making the material can be batch or continuous. The primary raw materials or minerals contain a source of source of silicon oxide, and a source of disodium oxide. Examples of sources of silicon oxide are silica sand, as well as quartzite and cristobalite. A disodium oxide may be needed to form the various silicate species, and can be obtained from, for example, trona, sodium carbonate, and sodium hydroxide. The raw materials are balanced to provide a multifunctional material having a desired or preferred SiO₂:Na₂O ratio or degree of polymerization. Other inorganic raw materials useful in laundry and cleaning products may optionally be included in the mixture, such as, for example, phosphorous oxide.

As mentioned above, the multifunctional materials of the present disclosure may be included in a cleaning product composition. Accordingly, the present disclosure provides, according to another specific example embodiment, cleaning product compositions comprising a multifunctional material and a surfactant. Such cleaning product compositions may be used as, for example, a personal cleaning product, a laundry detergent, a laundry aid, a dishwashing product, and a household cleaner.

Under the appropriate conditions, the multifunctional materials may perform several functions in a cleaning product composition including, but not limited to, water hardness removal, corrosion inhibition, provide alkalinity, carrier, processing aid (i.e., provides physical characteristics, such as proper pour or flow, viscosity, solubility, stability, and density), and antiredeposition. And when included in a cleaning product composition, the multifunctional material may, among other things, improve the performance of the cleaning product composition. The multifunctional material may be present in the cleaning product composition in a range of between about 3% to about 60% by weight of the cleaning product composition.

Any suitable surfactant may be used in the cleaning product compositions of the present disclosure. Suitable surfactants include, but are not limited to, anionic surfactants (e.g., linear alkylbenzene sulfonate (LAS), alcohol ethoxysulfates, alkyl sulfates, and soap), nonionic surfactants (e.g., alcohol ethoxylates), cationic surfactants (e.g., quaternary ammonium compounds), and amphoteric surfactants (e.g., imidazolines and betaines). The specific surfactant chosen may depend on the application or particular properties desired. For example, anionic surfactants may be chosen when the cleaning product is a laundry or hand dishwashing detergent, household cleaner, or personal cleansing product; nonionic surfactants may be chosen when the cleaning product is a laundry or automatic dishwasher detergent or rinse aid; cationic surfactants may be chosen when the cleaning product is a fabric softener or a fabric-softening laundry detergent; and amphoteric surfactants may be chosen for use when the cleaning product is a personal cleansing product or a household cleaning product.

The cleaning product compositions also may further comprise other optional components depending on, among other things, a desired application for a cleaning product composition and the desired properties of a cleaning product composition. For example, optional components may be added to provide a variety of functions, such as increasing cleaning performance for specific soils/surfaces, and ensuring product stability. The cleaning product compositions may be in any form, such as, for example, a dry detergent (e.g., a powder) or a liquid detergent (e.g., a gel or a spray). Similarly, the cleaning product compositions may be concentrated, either in a liquid or dry form.

A number of optional components may be included in the cleaning product compositions of the present disclosure. Examples of suitable optional components include, but are not limited to, disinfectants, bleaches, abrasives (e.g. calcite, feldspar, quartz, sand), bluings (i.e., a blue dye or pigment), enzymes (e.g., amylase, lipase, protease, cellulase), fabric softeners, hydrotropes (e.g., cumene sulfonates and ethyl alcohol to inhibit liquid products from separating into layers and/or to ensure product homogeneity), preservatives (e.g., butylated hydroxytoluene, thylene diamine tetraacetic acid, glutaraldehyde), fragrances, processing aids (e.g., clays, polymers, solvents, sodium sulfate), solvents (ethanol, isopropanol, propylene glycol), suds control agents (e.g., alkanolamides, alkylamine oxides, silicones), sodium tripolyphosphate (STPP), zeolites, foam inhibitors, optical brighteners, acids (e.g., acetic acid, citric acid, hydrochloric acid), and alkalis (e.g., ammonium hydroxide, ethanolamines, sodium carbonate, sodium hydroxide).

One specific example embodiment of a cleaning product composition may comprise LAS, a multifunctional material of the present disclosure, and sodium sulphate. In one aspect, the cleaning product may be formulated using 18 g of LAS, 41 g of a multifunctional material of the present disclosure having a SiO₂:Na₂O ratio of 1, and 41 g of sodium sulfate. In another aspect, the cleaning product may be formulated using 15 g of LAS, 31 g of a multifunctional material of the present disclosure having a SiO₂:Na₂O ratio of 1, and 54 g of sodium sulfate.

The cleaning product compositions may be formulated using methods known in the art. For example, solid, dry cleaning product compositions may be formulated using agglomerater techniques or with spray-drying techniques (e.g., using a tower) or both. Such products may be in the form of a hollow particle or a solid particle. The cleaning product compositions also may be formulated as liquid using methods known in the art. Likewise, the cleaning product compositions may in a concentrated or compacted form.

The present disclosure, according to another specific example embodiment, also provides methods of forming cleaning product compositions. Such methods generally comprise providing a surfactant and a multifunctional material and combining the surfactant and multifunctional material. In one aspect, cleaning product compositions may be formed by providing a surfactant and a polymerized silicate and combining the surfactant and polymerized silicate under conditions sufficient to at least partially depolymerize the polymerized silicate, thereby allowing the formation of a multifunctional material.

As mentioned above, the concentrations of monomer and polymer also depend in part on the silica content of the solution. Thus, for example, adding a silica source (e.g., colloidal silicate) to a high-ratio silicate solution may increase the SiO₂:Na₂O ratio, thereby forming more polymeric species. In general, as concentrated alkali metal silicate solutions are diluted (to a lower limit of ˜330 ppm), the pH and OH⁻ concentration are reduced, and silicate ions hydrolyze to form larger polymeric species and silicates with a lower SiO₂:Na₂O ratio. See R. K. Iler, The Chemistry of Silica, John Wiley and Sons, New York (1979). Solutions of soluble silicates are generally highly alkaline. When such highly alkaline soluble silicate solutions are neutralized by acid to a pH below about 10.7, the silicate ions decompose to silicic acid [Si(OH)₄], which then may polymerize to silica. For very dilute solutions (<˜300 ppm SiO₂), however, essentially complete depolymerization occurs and monomer (i.e., Si(OH)₄ and HSiO₃⁻) is the dominant species. As set forth above, monomeric species are better able to sequester cations (e.g., calcium cations) than polymeric species.

While silica content of the solution affects the degree of polymerization, the distribution of monomer and polymer species in an alkaline metal silicate solution also may vary based on changes in the solution's chemical environment. pH represents a significant property of the chemical environment. As pH of the solution decreases, the degree of polymerization increases. This affects various properties of the alkali metal silicate in solution. For example, as the degree of polymerization increases the water-softening ability of the alkali metal silicate decreases. Monomeric species, such as SiO₃²⁻, predominate at pHs above about 13. Polymeric species may form at pHs below about 13 and 11, with SiO₂O₅²⁻ as the principle ion. Colloidal particles predominate at pHs below about 9. Thus, increasing the pH of a high-ratio silicate solution may reduce the SiO₂:Na₂O ratio, thereby forming more monomeric silicate species.

The present disclosure, according to other embodiments, provides a method of regulating the degree of polymerization of an alkali metal silicate using pH. It also provides an alkali metal silicate solution having a pH-regulated degree of polymerization. According to a more specific embodiment, the degree of polymerization may be regulated using pH to be less than or equal to about 2.5. The solution may be an aqueous or other liquid solution. The solution may then include silicate anions of various distributions. Various factors may affect the properties of the silicate solution. One such factor may be the anionic species distribution (i.e., silicate speciation). Another factor may be pH.

In a specific embodiment, pH of the solution may be adjusted so that the degree of polymerization of the alkali metal silicate is less than or equal to about 2.5. In some embodiments, to achieve this degree of polymerization, pH of the solution may be about 11 or higher. In more specific embodiments, pH of the solution may be about 13 or higher.

Alkali metal silicate solutions with a pH-regulated degree of polymerization may be useful as one or more of the following: a builder, a conditioner, an alkaline agent, a filler, a carrier, an antiredeposition agent, a corrosion inhibitor, processing aid (i.e., provides physical characteristics, such as proper pour or flow, viscosity, solubility, stability, and density), and a neutralizing agent. Alkali metal silicate solutions with a pH-regulated degree of polymerization may be included in a cleaning product composition, and when included in such a composition, smaller amounts of active ingredients (or none at all, in some cases) may be used in the cleaning product composition while achieving the same or better cleaning performance. Alkali metal silicate solutions with a pH-regulated degree of polymerization may be capable of softening water and tend not to deposit on the fibers of the cloth being washed. Alkali metal silicate solutions with a pH-regulated degree of polymerization may also have improved builder properties and perform better than or equivalent to phosphate builders. When used in a cleaning product composition, alkali metal silicate solutions with a pH-regulated degree of polymerization may be capable of inhibiting the redeposition of soils, as well as inhibiting the corrosion of metals by, for example, synthetic detergents and complex phosphates. Alkali metal silicate solutions with a pH-regulated degree of polymerization also may supply and maintain alkalinity, which assists cleaning, help keep removed soil from redepositing during washing, and emulsify oily and greasy soils.

The alkali metal silicate solutions with a pH-regulated degree of polymerization of the present disclosure may be made using methods known in the art coupled with pH-regulation. For example, a builder may be made by mixing together two or more natural or partially treated (ground or comminuted) primary raw materials or minerals, in proportions according to the desired SiO₂:Na₂O ratio, raising the mixture to a reacting temperature, such as by introducing the mixture into a furnace, reacting the mixture at the reacting temperature, and forming the builder. One or more of the materials can be in the molten state upon mixing of the other ingredients. The process system for making the material can be batch or continuous. The primary raw materials or minerals contain a source of source of silicon oxide, and a source of disodium oxide. Examples of sources of silicon oxide are silica sand, as well as quartzite and cristobalite. A disodium oxide may be needed to form the various silicate species, and can be obtained from, for example, trona, sodium carbonate, and sodium hydroxide. The raw materials are balanced to provide an alkali metal silicate having a desired or preferred SiO₂:Na₂O ratio or. Other inorganic raw materials useful in laundry and cleaning products may optionally be included in the mixture, such as, for example, phosphorous oxide. The alkali metal silicate may then be placed in solution and its degree of polymerization regulated by adjusting pH.

As mentioned above, the alkali metal silicate solutions with pH-regulated degree of polymerization of the present disclosure may be included in a cleaning product composition. Accordingly, the present disclosure provides, according to another specific example embodiment, cleaning product compositions comprising an alkali metal silicate solution with pH-regulated degree of polymerization and a surfactant. Such cleaning product compositions may be used as, for example, a personal cleaning product, a laundry detergent, a laundry aid, a dishwashing product, and a household cleaner.

Under the appropriate conditions, the alkali metal silicate solutions with pH-regulated degree of polymerization may perform several functions in a cleaning product composition including, but not limited to, water hardness removal, corrosion inhibition, provide alkalinity, carrier, processing aid (i.e., provides physical characteristics, such as proper pour or flow, viscosity, solubility, stability, and density), and antiredeposition. And when included in a cleaning product composition, the solution may, among other things, improve the performance of the cleaning product composition. The solution may be present in the cleaning product composition in a range of between about 3% to about 60% by weight of the cleaning product composition.

To the extent any material affects the pH of a cleaning product, other materials may need to be added so that the pH of the cleaning product solution appropriate to regulate the degree of polymerization of the alkali metal silicate as desired.

Alkali metal silicate solutions of the present invention, which may include product made using these solution, such as cleaning products, may be supplied in any variety of forms. For example, they may be dried, a concentrated liquid, or a ready-to-use liquid. If supplied in a dried form, directions for formation of a solution may also be provided and the dried form may be constituted such that when the solution is made as directed, the degree of polymerization of the alkali metal silicate is regulated by pH. As another example, when the alkali metal silicate solution is supplied as a concentrated liquid, the pH of the concentrated liquid may be such that a desired degree of polymerization is present in the concentrated liquid. Alternatively, the concentrated liquid may be supplied with directions for use that include forming a more dilute solution in which pH will regulate the degree of polymerization to a desired level. In still other examples, a concentrated liquid may be formulated such that degree of polymerization is regulated to be a desired level both in the concentrated liquid form and when the liquid is diluted according to directions.

The cleaning product compositions may be formulated using methods known in the art coupled with pH-regulation. For example, solid, dry cleaning product compositions may be formulated using agglomerater techniques or with spray-drying techniques (e.g., using a tower) or both. Such products may be in the form of a hollow particle or a solid particle. The cleaning product compositions also may be formulated as liquid using methods known in the art. Likewise, the cleaning product compositions may in a concentrated or compacted form.

The present disclosure, according to another specific example embodiment, also provides methods of forming cleaning product compositions. Such methods generally comprise combining a surfactant and an alkali metal silicate solution having a pH-regulated degree of polymerization. In one aspect, cleaning product compositions may be formed by providing a surfactant and a polymerized silicate and combining the surfactant and polymerized silicate under pH conditions sufficient to at least partially depolymerize the polymerized silicate, thereby allowing the formation of an alkali metal silicate solution having a pH-regulated degree of polymerization.

To facilitate a better understanding of the present invention, the following examples of specific example embodiments are given. In no way should the following examples be read to limit or define the entire scope of the invention.

### EXAMPLE I

1.7 parts of soda ash (Na₂CO₃) and one part of sand (SiO₂) were blended in a mixer using a sodium silicate X(SiO₂). Y(Na₂O) solution where the ratio of X/ %Y is 2.35 and it has a strength of 2.5% solids as a binder; and using hot air (exhaust from smelter) to dry and preheat the mixture. The mixture was fed into a furnace and reacted for about 2 hours at 1100° C. to produce a melted product which was then cooled and ground with a hammer mill to obtain a product with detergent size particles.

### EXAMPLE II

1.7 parts of soda ash (Na₂CO₃) and one part of sand (SiO₂) with an average fine size (AFS) over 130 mesh were blended in a mixer using a sodium silicate X(SiO₂). Y(Na₂O) solution where the ratio of X/Y is about 2.35 and it has a strength of about 2.5% solids as a binder; and hot air (exhaust from calcinator) was used to dry and preheat the mixture. The mixture was fed into a rotary Kiln at a temperature of approximately 800° C. The product was then cooled and ground with a hammer mill to obtain a product with detergent size particles.

### EXAMPLE III

2.5 parts of caustic soda (NaOH) was diluted at 50% with water and one part of sand X(SiO₂) were fed into cylindrical pressure reactor (e.g., an autoclave) in which the hydrothermic reaction carried out is designed so that the mixture of sand and caustic soda present can be heated to reaction temperatures of approximately 150° C. to 180° C. Saturated steam was introduced until the desired reaction temperature was reached. The steam was introduced and at the same time some steam was vented in order to have a constant feed of such steam which besides heating the mixture at the same time agitated the mixture to maintain the reaction, this process takes from about 2-4 hours. Product was then cooled and ground with a hammer mill to obtain a product with detergent size particles of metasilicate penta hydrate.

### EXAMPLE IV

A builder of the present invention was made according to a method of the present invention and was used to prepare a detergent product using a standard spray-drying process for making detergent base granules. A slurry was prepared by mixing together the following liquid and solid ingredients in the following order: 17 parts sodium salt linear alkylbenzene sulfonate (NaLAS) diluted in water at about 40% solids; about 27 parts of a solid product X(SiO₂).Y(Na₂O).Z(H₂O), where the ratio of X to Y was about 1.1 and where Z has a value of 5; and about 45 parts sodium sulfate. The mixture was processed in a spray-drying tower with a co-current stream of hot drying air at about 225° C. inlet temperatures and about 100° C. drying air temperature at the outlet stream. The final product had a moisture content of about 5% determined at about 125° C.

### EXAMPLE V

A neutralizing agent of the present invention was made according to the process of the present invention and was used to prepare a detergent product using a standard spray-drying process for making detergent base granules. A mix slurry was prepared by mixing together the following liquid and solid ingredients in the following order: about 17 parts sodium salt linear alkylbenzene sulfonate (NaLAS) diluted in water at about 40% solids; approximately 27 parts of a solid product X(SiO₂).Y(Na₂O).Z(H₂O); where the ratio of X to Y was about 1.1 and where Z has a value of 5, and about 45 parts sodium sulfate. The mixture was processed in a spray-drying tower with a co-current stream of hot drying air at about 225° C. inlet temperatures and about 100° C. drying air temperature at the outlet stream. The final product had a moisture content of about 5% determined at approximately 125° C.

### EXAMPLE VI

In this example, the metasilicate partially substitutes for sodium tripolyphosphate (STPP) in a conventional detergent composition. A slurry containing partial metasilicate builder substitution was prepared as follows:

A slurry was prepared by mixing together the following liquid and solid ingredients in the following order: about 17 parts linear sodium alkylbenzene sulfonate (NaLAS) diluted in water at about 40% solids; about 10 parts of a solid product STPP (sodium tripolyphosphate); about 17 parts a solid product X(SiO₂).Y(Na₂O).Z(H₂O), where the ratio of X to Y was about 1.1 and wherein Z has a value of 5; and 45 parts sodium sulfate. The mixture was processed in a spray-drying tower with a co-current stream of hot drying air at about 225° C. inlet temperatures and about 100° C. drying air temperature at the outlet stream. The final product had a moisture content of about 5% determined at about 125° C.

### EXAMPLE VII

A metasilicate compound of the present invention was made according to a method of the present invention and compared to the calcium exchange capacity of sodium tripolyphosphate (STPP). The comparison was performed by reacting a preslurried sample with an excess of Ca⁺² and titrating the excess by reacting with standard EDTA (ethylene diaminetetracetic acid disodium salt) using eriochrome black T as indicator and maintaining pH control at 10 with a buffer solution of NH₄Cl and NH₄OH. The results showed a similar performance between the metasilicate compound and the STPP. The metasilicate compound had a capacity of 259 mgCaCO₃/gram versus 262 mgCaCO₃/gram STPP.

### EXAMPLE VIII

The calcium binding capacity of STPP was measured and compared to the calcium binding capacity of a multifunctional material example comprising sodium silicate having a SiO₂:Na₂O ratio of 1. The comparison is shown in Table 2.

The calcium binding capacity was determined by reacting a pre mixed sample solution with an excess of Ca²⁺ and titrating the excess Ca²⁺ with standard EDTA to determine the uptake of Ca²⁺. Results are calculated as milligrams of CaCO₃ per gram of the test sample, and calculated as follows:

$$Binding Capacity = \frac{( B - T ) \times f \times 100}{( SW ) \times ( solids )}$$

in which, B is the milliliters of EDTA for the blank titration, T is the milliliters of EDTA for the sample titration; F is the milligrams of CaCO₃ per milliliter of EDTA solution as determined in the standardization of EDTA procedure, SW is the sample weight in grams, and solids is the percent alumino silicate solids (100.00−(% H₂O+% Na₂CO₃)).

Briefly, 20 mL of distilled water was put into a 150 mL beaker. The sample was transferred into the beaker and stirred for 15 minutes. Then 20.0 mL of a stock Ca²⁺ solution was pipetted into the beaker and stirred for 15 minutes. The sample was uniformly dispersed with no large chunks. The mixture was then filtered through a 0.45 μm and into a clean 500 mL filtering flask for titration. Next, 15 mL of pH 10.0 Buffer, 5 mL of magnesium complex of EDTA, and 3-5 drops of EBT (Eriochrome Black T) indicator were added to the filtrate in the filtering flask (Buffer, magnesium complex EDTA, and EBT indicator were prepared as described below). A stirring bar was added to the filtering flask and the sample solution was titrated with EDTA solution to a blue endpoint (i.e., until all red color disappears and the solution is distinctly blue). 10-15 mL of the buffer solution was then added to the filtering flask. If a change occurred, the titration was continued. If no change occurred the titration was recorded. A blank titration was also prepared by titrating 10 mL of the Ca⁺² stock solution to which has been added 50 mL of distilled water, 15 mL of pH 10 Buffer, 5 mL of magnesium complex of EDTA solution, and 3-5 drops of EBT indicator.

The Buffer was prepared in two liter batches by weighing 35 g of NH₄Cl into a one liter volumetric flask, adding 500 mL distilled water, then adding 285 mL of concentrated NH₄OH, and diluting to volume with distilled water. The magnesium complex of EDTA was prepared by weighing into a 600 mL beaker 37.20 g of Na₂EDTA.2H₂O, adding 500 mL distilled water to completely dissolve the Na₂EDTA.2H₂O, then weighing 24.65 g of MgSO₄.7H₂O to the 600 mL beaker, adding a few drops of phenolphthalein indicator, then while stirring adding enough 50% NaOH solution to turn the solution just pink, dissolving the precipitate that forms when the phenolphthalein endpoint is reached with about 20 mL of 50% NaOH, and transferring the solution to a liter volumetric flask and dilute to volume with distilled water. When properly prepared, 5 mL of the solution should assume a dull violet color when treated with 10 mL of the pH 10.0 Buffer and a few drops of EBT indicator. The addition of a single drop of Na₂EDTA solution should turn the solution blue. If this condition is not met, additions of small amounts of MgSO₄.7H₂O or EDTA should be made to the liter volumetric flask until this test is satisfied. The EBT indicator was prepared by weighing 0.2000+0.01 g of the solid indicator into a 25 mL indicator bottle, adding 15 mL of triethanolamine and 5 mL of ethyl alcohol, and then the solution was swirled until the indicator was completely dissolved into a blue/black solution. The Na₂EDTA solution was prepared by weighing 78.00 g of Na₂EDTA.2H₂O into a liter volumetric flask, adding about 500 mL of hot distilled water while swirling until the Na₂EDTA.2H₂O was completely dissolved, and diluting to volume with distilled water.

As shown in Table 2, the multifunctional material example was about 20% better than STPP at binding calcium.

TABLE 2

| | | Multifunctional |
|---|---|---|
| | STPP | Material Example |
| Calcium Binding Capacity | 644.94 | 778.86 |
| (mg CaCO₃/g) | | |

### EXAMPLE IX

Several tests were conducted to determine the calcium binding capacity of monomeric and polymeric silicate species as compared to sodium tripolyphosphate (STPP), both as 1% solutions in water. As discussed above, the degree of polymerization is higher in higher SiO₂:Na₂O ratio silicates, and silicates may polymerize at lower pHs. To minimize pH induced polymerization, the pH of the water used to form the 1% solutions was adjusted to about 11.

The results of these tests described above are shown in Table 3.

TABLE 3

| | mg CaCO₃/g | mg CaCO₃/g |
|---|---|---|
| | (water not | (water adjusted |
| 1% solution of: | adjusted) | to pH 11) |
| STPP | 671.76 | |
| SiO₂:Na₂O ratio of 1.00 | 778.86 | 770.64 |
| SiO₂:Na₂O ratio of 1.20 | 666.38 | 710.34 |
| SiO₂:Na₂O ratio of 1.60 | 624.62 | 658.90 |
| SiO₂:Na₂O ratio of 2.35 | 528.23 | 603.43 |
| SiO₂:Na₂O ratio of 3.22 | 395.71 | 581.89 |

As shown in Table 3, lower SiO₂:Na₂O ratios, or monomeric silicate species, have a greater calcium binding capacity. Similarly, when the pH is adjusted to minimize pH induced silicate polymerization, the calcium binding capacity of even high SiO₂:Na₂O ratio silicates increases. The increased pH allows more monomeric species to form, even with high ratio silicates, and also inhibits the further polymerization of silicates with lower degrees of polymerization.

### EXAMPLE X

The properties of a number of comparative detergent samples were tested to determine pH at 1% solution, solubility, and calcium binding capacity. The comparative test samples included STPP, an alkali metal silicate solution comprising sodium silicate having a SiO₂:Na₂O ratio of 1, model laundry detergents, and a model dishwashing detergent. The comparative test samples are shown in Table 4.

TABLE 4

| Comparative Test | |
|---|---|
| Sample | Composition |
| 1 | granular STPP |
| 2 | ground STPP |
| 3 | alkali metal silicate solution |
| 4 | laundry detergent: 18% LAS, 24% STPP, 6% sodium silicate with a |
| | SiO₂:Na₂O ratio of 2.35; 11% Na₂CO₃, 41% Na₂SO₄ |
| 5 | laundry detergent: 18% LAS, 24% STPP, 7% sodium silicate with a |
| | SiO₂:Na₂O ratio of 2.35; 11% Na₂CO₃, 40% Na₂SO₄ |
| 6 | laundry detergent: 18% LAS, 24% STPP, 7% sodium silicate with a |
| | SiO₂:Na₂O ratio of 2.35; 11% Na₂CO₃, 40% Na₂SO₄ |
| 7 | laundry detergent: 15% LAS, 15% STPP, 7.5% sodium silicate with a |
| | SiO₂:Na₂O ratio of 2.35; 8.5% Na₂CO₃, 54% Na₂SO₄ |
| 8 | laundry detergent: 15% LAS, 12% STPP, 10% sodium silicate with a |
| | SiO₂:Na₂O ratio of 2.35; 9% Na₂CO₃, 54% Na₂SO₄ |
| 9 | laundry detergent: 18% LAS, 12% STPP, 10% sodium silicate with a |
| | SiO₂:Na₂O ratio of 2.35; 0% Na₂CO₃, 55% Na₂SO₄ |
| 10 | laundry detergent: 18% LAS, 24% STPP, 6% sodium silicate with a |
| | SiO₂:Na₂O ratio of 2.35; 0% Na₂CO₃, 55% Na₂SO₄ |
| 11 | dishwashing detergent: 22% LAS, 3% STPP, 10% sodium silicate with |
| | a SiO₂:Na₂O ratio of 2.35; 12% Na₂CO₃, 53% Na₂SO₄ |
| 12 | laundry detergent: 18% LAS, 24% STPP, 6% sodium silicate with a |
| | SiO₂:Na₂O ratio of 2.35; 11% Na₂CO₃, 41% Na₂SO₄ |
| 13 | laundry detergent: 18% LAS, 41% alkali metal silicate solution, 41% |
| | Na₂SO₄ |
| 14 | laundry detergent: 15% LAS, 12% STPP, 10% sodium silicate with a |
| | SiO₂:Na₂O ratio of 2.35; 9% Na₂CO₃, 54% Na₂SO₄ |
| 15 | laundry detergent: 15% LAS, 41% alkali metal silicate solution, 44% |
| | Na₂SO₄ |

A black fabric test was also conducted to measure the deposition of particles on a sample of black fabric. This test is a practical method to approximate what might be seen by the consumer, as particles that deposit on black fabric may look like white lint or powder. The black fabric test was generally carried out as follows. The sample to be tested was mixed and 1.5 grams was weighed out. A 1 liter aliquot of water was equilibrated at the test temperature of about 20° C. The test sample was then added to a Terg-O-Tometer followed by the 1 liter aliquot. Next, the sample was agitated for 10 minutes at 50 rpm in the Terg-O-Tometer. At the end of agitation period, the entire contents are poured onto a 90 millimeter Buchner funnel, covered with a black test fabric, such as “C70” available from EMC, and filtered through the black test fabric using standard suction filtration. The Terg-O-Tometer was then rinsed with 500 milliliters of additional water with the same hardness and temperature and poured through the fabric on the Buchner funnel. After filtration, the black fabric was dried at room temperature. The appearance of the fabric was then visually graded on a 1-10 scale, 1 being the worst, i.e., with the most insoluble particles on the fabric, while a grade of 10 is the best.

The results of the tests and a comparison of the samples is shown in Table 5.

TABLE 5

| | | | Calcium binding | | |
|---|---|---|---|---|---|
| Sample | | % moisture | Capacity | Solubility Test | |
| No. | pH | (105° C.) | (mg CaCO₃/g) | Appearance | Black Fabric Test |
| 1 | 9.4 | 6.47 | 671.76 | Clear without insolubles | not tested |
| 2 | 9.7 | 0.38 | 644.94 | Clear without insolubles | not tested |
| 3 | 12.7 | 23.57 | 778.86 | Clear without insolubles | not tested |
| 12 | 10.9 | 8.27 | 318.77 | Turbid insolubles | not tested |
| 13 | 12.3 | 5.69 | 525.56 | Clear without insolubles | 9 |
| 14 | 10.7 | 4.88 | 237.66 | Turbid insolubles | not tested |
| 15 | 12.2 | 5.0 | 543.25 | Clear without insolubles | 10 |
| 15 | 12.3 | 7.69 | 522.37 | Clear without insolubles | 10 |
| 4 | 10.8 | 5.56 | 395.56 | Turbid insolubles | 5 |
| 5 | 10.9 | 5.04 | 341.39 | Turbid insolubles | not tested |
| 6 | 10.7 | 7.38 | 288.94 | Turbid insolubles | not tested |
| 7 | 10.5 | 3.76 | 377.02 | Turbid insolubles | not tested |
| 8 | 10.7 | 5.50 | 258.17 | Turbid insolubles | 4 |
| 9 | 10.6 | 8.04 | 228.22 | Turbid insolubles | not tested |
| 10 | 10.6 | 3.22 | 209.38 | Turbid insolubles | not tested |
| 11 | 10.7 | 3.65 | 110.93 | Turbid insolubles | not tested |

As seen from Table 5, the addition of an alkali metal silicate in solution to a detergent improves the detergent's performance. Detergents formulated with the alkali metal silicate solutions had a higher calcium binding capacity, better solubility, and less undesirable white precipitate on black fabric, as compared to the other detergents tested. As Table 5 shows, examples with a higher pH performed better in the black fabric test, were more likely to be clear without insolubles, and had a higher calcium binding capacity. In addition, detergents formulated using the alkali metal silicate solution required less total material, and therefore may be more cost effective to manufacture.

### EXAMPLE XI

Comparative detergents were formulated using either STPP or an alkali metal silicate solution including sodium silicate having a SiO₂:Na₂O ratio of 1, and the properties of the resulting detergents were compared. The calcium binding capacity of a detergent having STPP and either more surfactant (comparative sample no. 1) or less surfactant (comparative sample no. 3) were compared to comparative example detergents of the present disclosure having the an alkali metal silicate solution and more surfactant (comparative sample no. 2) or less surfactant (comparative sample nos. 4 and 5). The components of the comparative samples are shown in Table 6 and the performances of the comparative samples are shown in Table 7.

In comparative sample nos. 1 and 3, a sodium hydroxide solution was used to neutralize LAS, forming NaLAS. In comparative sample nos. 2 and 5, the alkali metal silicate solution is combined with a sodium hydroxide solution, which is then combined with LAS to form NaLAS. In comparative sample no. 4, a sodium hydroxide solution was used to neutralize LAS, forming NaLAS, then the alkali metal silicate was added. When forming a solution, the order of addition may be significant because if the pH becomes too low, then precipitation may occur. Because of this, in certain embodiments, the silicate may be added to the water.

Table 7 shows that detergents formulated with an alkali metal silicate have a higher calcium binding capacity, are more soluble, and perform better when tested using the black fabric test, as compared to detergents formulated with STPP.

TABLE 6

| DETERGENT | COMPARATIVE SAMPLE NUMBER | | | | |
|---|---|---|---|---|---|
| COMPONENTS | 1 | 2 | 3 | 4 | 5 |
| NaLAS (caustic) | 18% | — | 15% | 15% | — |
| NaLAS | — | 18% | — | — | 15% |
| (prototype) | | | | | |
| STPP | 24 | — | 12% | — | — |
| Example | — | 41% | — | 31% | 31% |
| multifunctional | | | | | |
| material | | | | | |
| Sodium Silicate | 6% | — | 10% | — | — |
| (SiO₂:Na₂O ratio of 2.35) | | | | | |
| Soda (Na₂CO₃) | 11% | — | 9 | — | — |
| Sodium sulphate | 41% | 41% | 54% | 54% | 54% |
| (Na₂SO₄) | | | | | |

TABLE 7

| PER- | COMPARATIVE SAMPLE NUMBER | | | | |
|---|---|---|---|---|---|
| FORMANCE | 1 | 2 | 3 | 4 | 5 |
| Calcium binding | 318.77 | 525.56 | 237.66 | 543.25 | 522.37 |
| Capacity | | | | | |
| (mg CaCO₃/g) | | | | | |
| Black | 5 | 9 | 4 | 9 | 10 |
| Fabric Test | | | | | |
| Solubility Test | Slightly | Clear | Turbid with | Clear | Clear |
| & Appearance | turbid, | without | insolubles | without | without |
| | few | in- | | in- | in- |
| | insolubles | solubles | | solubles | solubles |

While embodiments of this disclosure have been depicted, described, and are defined by reference to example embodiments of the disclosure, such references do not imply a limitation on the disclosure, and no such limitation is to be inferred. The subject matter disclosed is capable of considerable modification, alteration, and equivalents in form and function, as will occur to those ordinarily skilled in the pertinent art and having the benefit of this disclosure. The depicted and described embodiments of this disclosure are examples only, and are not exhaustive of the scope of the disclosure.

1. A material comprising a solution of an alkali metal silicate wherein,
a) at least portion of the alkali metal silicate is monomeric;
b) the alkali metal silicate has a degree of polymerization less than or equal to about 2.5; and
c) the pH of said solution of the alkali metal silicate is about 11 or higher to about 13 or higher.

2. The material of claim 1, wherein the degree of polymerization of the alkali metal silicate is about 1, about 1.5, about 2.0, or about 2.5.

3. The material of claim 1, wherein the alkali metal silicate is sodium silicate.

4. The material of claim 1, wherein the alkali metal silicate is potassium silicate.

5. The material of claim 3, wherein the alkali metal silicate has a SiO₂:Na₂O ratio of from about 0.5 or higher to about 4.0 or higher.

6. The material of claim 3, wherein the alkali metal silicate has a SiO₂:Na₂O ratio of from about 2 or higher.

7. The material of claim 3, wherein the alkali metal silicate has a SiO₂:Na₂O ratio of from about 2.5 or higher.

8. The material of claim 3, wherein the alkali metal silicate has a SiO₂:Na₂O ratio of from about 3 or higher.

9. The material of claim 1, wherein the pH is about 11 or higher.

10. The material of claim 1, wherein the pH is about 12 or higher.

11. The material of claim 1, wherein the pH is about 13 or higher.

12. A cleaning product composition comprising, a material comprising a solution of an alkali metal silicate wherein,
a) at least portion of the alkali metal silicate is monomeric;
b) the alkali metal silicate has a degree of polymerization less than or equal to about 2.5; and
c) the pH of said solution of the alkali metal silicate is about 11 or higher to about 13 or higher.

13. The cleaning product composition of claim 12, wherein the cleaning product is a liquid detergent.

14. The cleaning product composition of claim 12, wherein said material is used in an amount of from about 3% to about 60%, by weight of the cleaning product composition.

15. The cleaning product composition of claim 12, further comprising a surfactant.

16. The cleaning product composition of claim 15, wherein the surfactant is chosen from at least one of an anionic surfactant, a nonionic surfactant, a cationic surfactant, and an amphoteric surfactant.

17. The cleaning product composition of claim 15, wherein the surfactant further comprises a linear alkyl benzene sulfonate.

18. The cleaning product composition of claim 13, wherein the surfactant is used in an amount in the range of from about 1% to about 50% by weight of the detergent.

19. The cleaning product composition of claim 12, further comprising a disinfectant, a bleach, an abrasive, a bluing agent, an enzyme, a fabric softener, a hydrotrope, a preservative, a fragrance, a processing aid, a solvent, a suds control agent, sodium tripolyphosphate, a zeolite, a foam inhibitor, an optical brightener, an acid, a base, ammonium hydroxide, ethanolamines, sodium carbonate, sodium hydroxide or any combination thereof.

20. A method for making a cleaning product composition comprising combining a material and a surfactant wherein, the material comprises a solution of an alkali metal silicate wherein,
(i) at least portion of the alkali metal silicate is monomeric;
(ii) the alkali metal silicate has a degree of polymerization less than or equal to about 2.5; and
(iii) the pH of the solution of the alkali metal silicate is about 11 or higher to about 13 or higher.

21. The method of claim 20, wherein the degree of polymerization of the alkali metal silicate is about 1, about 1.5, about 2.0 or about 2.5.

22. The method of claim 20, wherein the alkali metal silicate is sodium silicate or potassium silicate.

23. The method of claim 22, wherein the alkali metal silicate is sodium silicate.

24. The method of claim 22, wherein the alkali metal silicate has a SiO₂:Na₂O ratio of from about 0.5 or higher to about 4.0 or higher.

25. The method of claim 22, wherein the alkali metal silicate has a SiO₂:Na₂O ratio of from about 2 or higher.

26. The method of claim 22, wherein the alkali metal silicate has a SiO₂:Na₂O ratio of from about 2.5 or higher.

27. The method of claim 22, wherein the alkali metal silicate has a SiO₂:Na₂O ratio of from about 3 or higher.

28. The method of claim 20, wherein the pH is about 11 or higher.

29. The method of claim 20, wherein the pH is about 12 or higher.

30. The method of claim 20, wherein the pH is about 13 or higher.

31. The method of claim 20, further comprising combining with the material and the surfactant, a disinfectant, a bleach, an abrasive, a bluing agent, an enzyme, a fabric softener, a hydrotrope, a preservative, a fragrance, a processing aid, a solvent, a suds control agent, sodium tripolyphosphate, a zeolite, a foam inhibitor, an optical brightener, an acid, a base, ammonium hydroxide, ethanolamines, sodium carbonate, sodium hydroxide, or any combinations thereof.

32. A method for regulating the degree of polymerization of an alkali metal silicate in solution comprising:
a) providing a solution of an alkali metal silicate; and
b) regulating the pH of the solution to a value of about 10 or higher;
wherein the value of pH results in a desired degree of polymerization of the alkali metal silicate in the solution.

33. The method of claim 32, wherein the desired degree of polymerization of the alkali metal silicate is about 1, about 1.5, about 2.0 or about 2.5.

34. The method of claim 32, wherein the solution is an aqueous solution.

35. The method of claim 32, wherein the alkali metal silicate comprises sodium silicate or potassium silicate.

36. The method of claim 35, wherein the alkali metal silicate has a SiO₂:Na₂O ratio about 4 or above.

37. The method of claim 35, wherein the alkali metal silicate has a SiO₂:Na₂O ratio about 3 or above.

38. The method of claim 35, wherein the alkali metal silicate has a SiO₂:Na₂O ratio about 2 or above.

39. The method of claim 35, wherein the alkali metal silicate has a SiO₂:Na₂O ratio about 1 or above.

40. The method of claim 35, wherein the alkali metal silicate has a SiO₂:Na₂O ratio of from about 0.5 to about 4.0.

41. The method of claim 32, wherein the pH value is about 11 or higher.

42. The method of claim 32, wherein the pH value is about 12 or higher.

43. The method of claim 32, wherein the pH value is about 13 or higher.

44. A method for making an alkali metal silicate solution comprising monomers of the alkali metal silicate, said method comprising:
a) providing an initial solution of an alkali metal silicate characterized by a degree of polymerization greater than about 2.5;
b) adjusting the pH of the initial solution to a level sufficient to shift the degree of polymerization of the alkali metal silicate to a level less than or equal to about 2.5.

45. The method of claim 44, wherein the alkali metal silicate comprises sodium silicate or potassium silicate.

46. The method of claim 45, wherein the alkali metal silicate has a SiO₂:Na₂O ratio about 2 or above.

47. The method of claim 45, wherein the alkali metal silicate has a SiO₂:Na₂O ratio about 1 or above.

48. The method of claim 44, wherein the pH is adjusted to about 11 or higher.

49. The method of claim 44, wherein the pH is adjusted to about 12 or higher.

50. The method of claim 44, wherein the pH is adjusted to about 13 or higher.

51. The method of claim 44, further comprising selecting the pH based upon the alkali metal silicate.

52. The method of claim 44, further comprising selecting the pH based upon the SiO₂:Na₂O ratio of the alkali metal silicate.

53. A method for cleaning comprising contacting a surface with a solution comprising an alkali metal silicate having a degree of polymerization less than or equal to about 2.5, wherein the solution has a pH selected to regulate the degree of polymerization of the alkali metal silicate.

54. A method according to claim 53, wherein the surface is selected from the group consisting of a fabric, a household surface, a textile, a food preparation or service surface, a biological surface, and combinations thereof.
